(19) United States
(12) Patent Application Publication
(10) Pub. No.: US 2015/0278763 A1
(43) Pub. Date: Oct. 1, 2015

(54) Intelligent Social Business Productivity

(71) Applicant: International Business Machines Corporation, Armonk, NY (US)

(72) Inventors: Rajesh Patil, Pune (IN); Fernando Salazar, Pune (IN)

(73) Assignee: International Business Machines Corporation, Armonk, NY (US)

(21) Appl. No.: 14/225,898

(22) Filed: Mar. 26, 2014

(51) Int. Cl. G06Q 10/10; G06Q 50/00; G06F 17/30

(52) U.S. Cl. CPC G06Q 10/103; G06F 17/30598; G06Q 50/01

(57) ABSTRACT

Receiving items of work from various sources, applying analytics to obtain metadata about the items of work, and then applying further analytics to classify each item of work into one or more work domains in a model of work. User feedback is received regarding the accuracy of the classification decisions, and the computer-based classification analytics are updated accordingly.

### BACKGROUND OF THE INVENTION

The present invention relates generally to the field of social computing, and more particularly to integrated work management.

Social computing is rapidly becoming the preeminent paradigm for business software users to perform collaborative activities necessary for modern business operations. The benefits of social computing are in the ways it more naturally enlists people to work together on team goals, and in how it lowers barriers to content creation and sharing. For example, prior to social computing, documents would typically be prepared according to the following process: (i) one person generates an initial draft; (ii) that person saves the draft as a document file in word processing format; (iii) that person emails the document file to a group of persons for comments and edits; and (iv) someone subsequently organizes and merges all the resulting individual versions of the document to form a new draft with everybody's input accepted (as appropriate). With social computing, the document can be embodied in a wiki, which is a type of web application that supports consistent editing of documents by teams of persons.

Another example of social computing benefits is in newsfeeds or activity streams. Prior to social computing, if someone was working on a difficult problem, they might ask a co-worker for help, either by email or via a one-on-one conversation. With social computing, a user typically posts her status as a microblog post, which effectively communicates that she is working on a problem. This microblog post will typically be presented in the newsfeed of each of the user's contacts. These other users (that is, the original user's contacts) are able to respond directly, or they may even share the original post with their own contacts, ultimately enlisting a far larger group of possible assistants than the original user would typically have contacted on her own.

### SUMMARY

According to one aspect of the present disclosure, there is a computer program product, system and/or method which performs the following actions (not necessarily in the following order and not necessarily in serial sequence): (i) receives a first item of work; (ii) applies, by an analytics service module, a first set of analytics to data pertaining to the first item of work to obtain metadata about the first item of work; (iii) applies, by an intelligent work manager module, a second set of analytics to the data and/or metadata to classify the first item of work as belonging to a first work domain in a model of work; (iv) receives user feedback regarding the accuracy of the classification of the first item of work; and (v) responsive to the user feedback, updates the second set of analytics such that a second item of work, when received, is classified differently than it would have been had the feedback not been received. At least part of the classification of the first item of work is performed by a machine using machine logic.

### BRIEF DESCRIPTION OF THE SEVERAL VIEWS OF THE DRAWINGS

FIG. 1 is a schematic view of a first embodiment of a networked computers system according to the present invention;

FIG. 2 is a flowchart showing a process performed, at least in part, by the first embodiment system;

FIG. 3 is a schematic view of a portion of the first embodiment system;

FIG. 4 is a schematic view of a second embodiment system;

FIG. 5 is a schematic view of a third embodiment system;

FIG. 6 is an organizational diagram used by the second embodiment system; and

FIG. 7 is an organizational diagram used by the third embodiment system.

### DETAILED DESCRIPTION

Some embodiments of the present invention employ analytics, aggregate statistics, and machine learning to automatically federate items of work from disparate sources and index, classify, tag, and link these items according to a model of work. In so doing, these embodiments may improve the efficiency of users to organize and manage their work.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

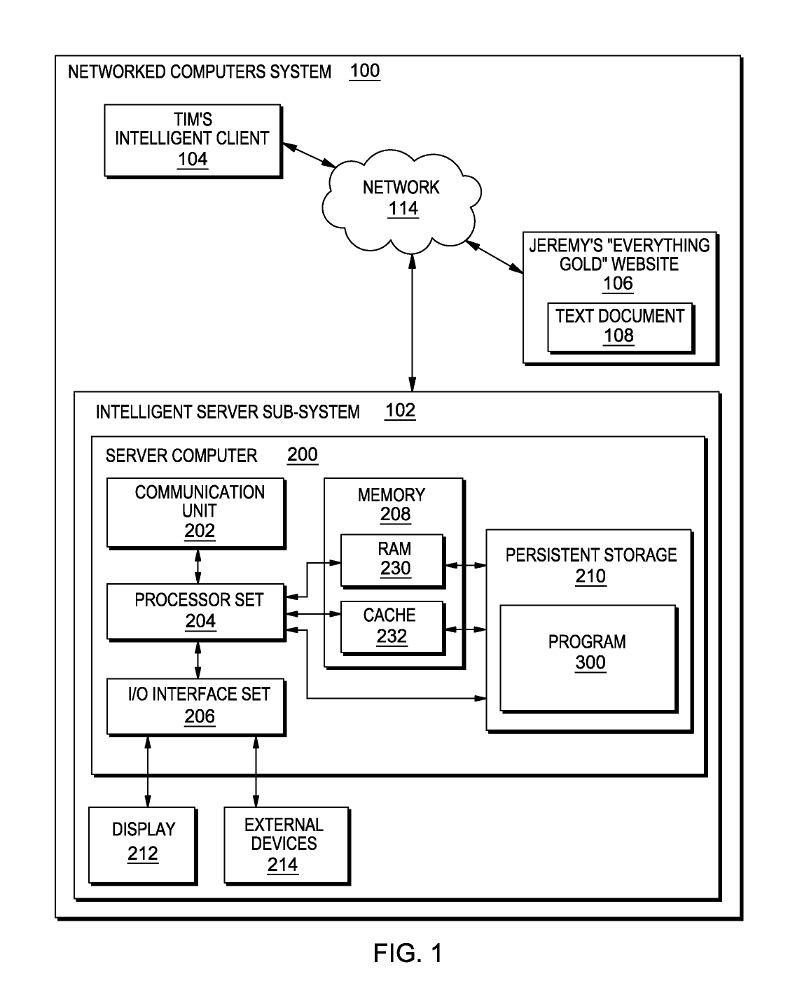

An embodiment of a possible hardware and software environment for software and/or methods according to the present invention will now be described in detail with reference to the Figures. FIG. 1 is a functional block diagram illustrating various portions of networked computers system 100, including: intelligent server sub-system 102; Tim's intelligent client sub-system 104; Jeremy's “Everything Gold” website 106; text document 108; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

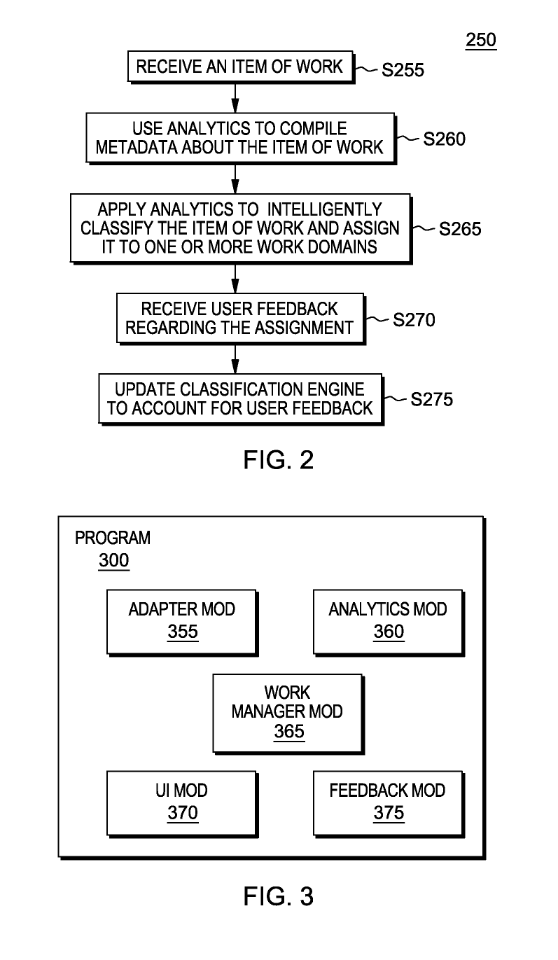

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where adapter mod 355 of program 300 receives an item of work to process in service of Tim's intelligent client 104 (see FIG. 1). The item of work is text document 108, posted on Jeremy's “Everything Gold” website 106. Alternatively, the item of work may be an email, a blog post, a picture, a video, a live webcam feed, a spreadsheet, a webpage, a presentation, or just about any other delineated unit of data capable of being stored on a software storage device and being processed by a computer. In general, the item of work may be created by Tim, or it may be created by someone else, and it could reside on the device containing intelligent client 104, or it could reside anywhere else where it is accessible to intelligent server sub-system 102 and program 300. Adapter mod 355 contains any number of sub-mods (not shown) that can access various sources of data and process the data they contain. For example, adapter mod 355 contains a sub-mod for accessing websites.

In general, various actions may trigger reception of an item of work. These may include, but are not necessarily limited to: (i) creation of a new work item, such as a document, by the user; (ii) downloading or accessing a local or cloud-based item by the user; (iii) joining a new social community or subscribing to a new blog or newsfeed, whether done by the user or on the user's behalf; and/or (iv) updates or additions made by others to specific content or in a delineated virtual community or content domain to which a user subscribes or which is related to existing items of work in the user's model of work (see below).

Processing proceeds to step S260, where analytics mod 360 generates and compiles various types of metadata about the item of work. In general, such metadata may be direct, such as the email address of the sender, or derived, such as the number of times a particular phrase appears. Derived metadata may be derived via basic analytics, such as phrase counting, or advanced analytics, such as natural language processing. For text document 108 received from website 106, analytics mod 360 performs basic processing such as creating a full-text index (aggregated into a master index across all items of work), counting the frequency with which each word appears, and counting the frequency of each phrase. It also collects basic metadata including the document source (website 106), the author of the document (if available), and the document type (plain text document). Analytics mod 360 performs advanced processing as well, including natural language processing to determine what the document is about. It performs a search to determine the number of references made to the document from other locations on the network, as well as the number of references made from the document to other locations on the network. Particular note is made of references to or from locations already associated with one or more work domains in Tim's model of work (see below).

Different types of processing are used on different data sources. For instance, in the case of a video, advanced processing in the form of an object detection algorithm is employed to determine the presence of various types of objects or entities that are present in the video, and these object types are then ranked by apparent relative importance based, in part, on how often each appears. In general, different types of processing and different processing techniques may be employed based on various non-exclusive factors such as data source, data type, and analytics module configuration, as well as constraints on time, processing power, storage, or financial cost. Analytics mod 360 may also receive hints or other direction from work manager mod 365 (discussed below) to help focus its analysis based on an existing model of work and the success of work manager 365 in making correct assignments of work items to that existing model.

Processing proceeds to step S265, where work manager mod 365 uses the metadata generated and compiled by analytics mod 360 to assign the received item to one or more domains in the model of work set up for Tim's intelligent client 104 (see FIG. 1). For example, Tim has created a model of work that includes a base domain, or realm, of “investment management”, a child domain, or project, of the “investment management” realm entitled “gold”, and a child domain, or task, of the “gold” project entitled “collect and review information on gold investment vehicles”.

Based on the analysis performed by analytics mod 360 of text document 108, including the source of the document (website 106), the contents of the document, and a determination that the document is about different ways to invest in gold, work manager mod 365 determines that document 108 belongs with task “collect and review information on gold investment vehicles”, and automatically assigns the text document to that task. By virtue of the model of work, discussed above, document 108 is also automatically associated with the parent project and realm of this task.

In general, the model of work is a user-defined relationship of work domains, with narrower domains defined as subsets of one or more broader domains. Work manager mod 365 assigns received items of work to one or more work domains by applying analytics to metadata about the item that was compiled by analytics mod 360. There are numerous analytics that work manager 365 can apply. They may be based on a single metadata item, such as author name, or multiple metadata items, such as author name and subject matter (as derived, perhaps, from natural language processing). They may be based only on metadata about the item itself, such as in the rule “if an item is authored by Bob, assign it to project X”, or based on comparative metadata, such as in the rule “if an item is authored by Bob, assign it to every project where more than 30% of the items already assigned to the project are authored by Bob”. They may be probabilistic (“if an item contains the words “commercial” and “fishing”, there is a 60% probability it should be assigned to project X”; . . . ; “assign the item to a project based on the highest calculated probability of a correct assignment”) or based on weights (“if there is a conflict between criteria, give more weight to subject than to author when deciding on an assignment”). They may be multi-step, based on an intermediate assignment to categories (“if an item contains the words “commercial” and “fishing”, it belongs to the category “commercial fishing”; assign items having category “commercial fishing” to project X). Work manager mod 365 begins with simple rules and refines them as necessary based on user feedback, discussed next. This feedback-based refinement makes the analytics used by work manager mod 365 adaptive analytics.

Processing proceeds to step S270, where, via user interface mod 370, program 300 receives user feedback about the automatic association. This occurs if and when Tim decides the association was incorrect, and either changes the association of document 108 to one or more different work domains or requests a different automatic assignment. In some embodiments, the user may also provide the system with more specific indicators of why the item was reclassified, such as key words or phrases, or the source of the item, which the system can then use to adjust its classification scheme. User interface mod 370 is a “back-end” for the actual user interface, which resides on intelligent client 104. In alternative embodiments, program 300 may not be located on server sub-system 102 but may instead be part of client 104. In general, the functionality of the intelligent work management system, which includes intelligent client 104 and intelligent server sub-system 102, may be split arbitrarily between any number of computing devices.

Processing proceeds to step S275, where feedback mod 375 uses Tim's feedback on the automatic assignment to update the classification scheme used by work manager mod 365 to assign work items to work domains. This update happens “automatically” by virtue of document 108, and thus its associated metadata, now being associated with a different work domain(s). Alternatively or in addition, other feedback mechanisms may be used, such as manually adjusting the weights given to various pieces of the metadata compiled by analytics mod 360 when determining relevance, and/or manually adjusting a threshold by which work management mod 365 determines a match has been found.

Once an appropriate assignment to work domain(s) has been made, that assignment can be used to enhance a user's work experience in various ways. For instance, Tim can perform a search only on his work items that are part of the “gold” project, and document 108 will be included in the search results. Tim can now also see attributes of document 108 such as link count, reference count, number of likes, number of replies, number of shares, and so on, which he can use in assessing the priority of the document relative to other items of work associated with his “collect and review information on gold investment vehicles” task. In a case where the work item associated with the “gold” project is a communication that Tim is composing, Tim can benefit from suggested recipients (including forums or groups) based on his communication's association with the project, the communication's content, and the association of other individuals or forums with the project, as well as the content of other items attributed to them. In other embodiments, other factors and factor combinations may be employed.

Generally speaking, the work item data that is analyzed may include data internal to the item, such as its substantive content and/or other intrinsic data such as “wrapper” information about the item like title, author, and data type. Alternatively or in addition, it may include contextual or extrinsic data about the item, such as source and date retrieved. One type of data is “social” data, which may be either intrinsic or extrinsic. Such data could include, but need not be limited to, number of “likes”, number of “shares”, and/or number of replies, as well as comments or reviews about the item or its author, and/or references to the item from other places in the user's public or private networks, or vice versa, especially to (or from) other items already in or otherwise associated with the user's model of work.

Similarly, factors used for categorizing an item and assigning it to a work domain may include basic internal data such as counts of words or phrases, basic contextual data such as author or source, data resulting from sophisticated internal processing such as natural language understanding, and data resulting from sophisticated contextual processing such as a digest of what others are saying about the item.

### III. Further Comments and/or Embodiments

Some embodiments of the present invention recognize the following facts, potential problems and/or potential areas for improvement with respect to the current state of the art: (i) while the benefits of social computing are potentially powerful, the way that social computing is being realized has led to a number of problems; (ii) previous forms and channels of collaboration, such as email or document repositories, are still in use, and because of their ability to easily extend outside organizations, they are unlikely to be discarded, so users need to access the old models while they derive benefits from the new, but the divergence in paradigms between prior-generation systems like email and newer social systems results in confusion and difficulty for users; (iii) even within the domain of social computing itself there is a diverse multitude of systems that users must access (for example, a worker in a modern information-centric organization must work with one or more “enterprise” social deployments within their company, with external and/or third-party social business systems, with consumer-oriented social systems, and finally with a number of document- and/or content-management systems), and workers today typically move back and forth between browser pages for all these separate systems and applications, relying on their own personal skills to organize that work and keep it consistent; (iv) knowledge work is becoming increasingly complex; (v) while the growing complexity of knowledge work is not a direct result of social computing, social computing enables workers to engage on an ever greater number of projects, documents, or topics and with an ever greater number of people, leading to more engagements; (vi) greater complexity leads to reduced productivity per single engagement; and/or (vii) while people and organizations have been and still are deriving benefits from social computing, those benefits fall short of social computing's potential, due to (a) the separate and un-connected nature of the many systems users must interact with and (b) the ever-greater number of data sources, topics, and people with which workers must engage.

Some embodiments of the present invention may include an intelligent client that unites in one user-experience one, or more, of the following features, characteristics, capabilities, and/or advantages: (i) a single “universal message” model whereby users can compose emails, blog posts, activity entries, status updates, and other collaborative or social items using a single common interface; (ii) a credentials service whereby authentication credentials for multiple back-end systems, such as email accounts, social accounts, and so forth are stored securely under control of a master authentication mechanism; (iii) a federation service whereby users gather together received email messages, subscribed status updates, activity items and updates, newsfeed entries, blog post updates, documents in document management repositories and/or data from other data sources into a single, coordinated model; (iv) an indexing service whereby all federated items are indexed for subsequent retrieval; (v) a local storage service, whereby certain classes and/or selected instances of data items can be maintained in storage local to the user, for example on a laptop (the benefits of local storage include but are not limited to: (a) the ability to work on items while the network is unavailable, and/or (b) the ability to work on items when their primary storage location is unavailable, though a great many of the items managed and indexed by the intelligent client may always be maintained only in remote storage); (vi) an analytics service where, through aggregate statistics and machine learning, federated items are classified and tagged, all of which is then used in service of “smart” client user-scenarios; (vii) a model of work, whereby users organize the many disparate activities they perform into “realms,” “projects,” and “tasks,” and where items of work such as documents, email messages, social updates, and the like can then be linked to the work model, either automatically based on analytics or manually, enabling users to better act on their priorities and to spend less time on the mechanics of sending emails, making blog posts, and other such process details; (viii) calendaring and contacts management, similar to existing email or personal information management (PIM) services but that reflect the federation capabilities of the client and the model of work (for example, users can manage in one view multiple calendars from different accounts, and at the same time on their calendar see due dates and other milestones that come from their model of work); (ix) a dashboard as an entry point to the user interface, showing key events and status for realms, projects, and so forth; (x) a single system to see updates/data across all systems relevant to the user; (xi) a unified interface for data/document creation targeted at multiple systems; (xii) powerful capabilities like search and analytics that add intelligence and greater organization to a user's work; and/or (xiii) a simple yet powerful model of domains and tasks that enables users to better structure their activities.

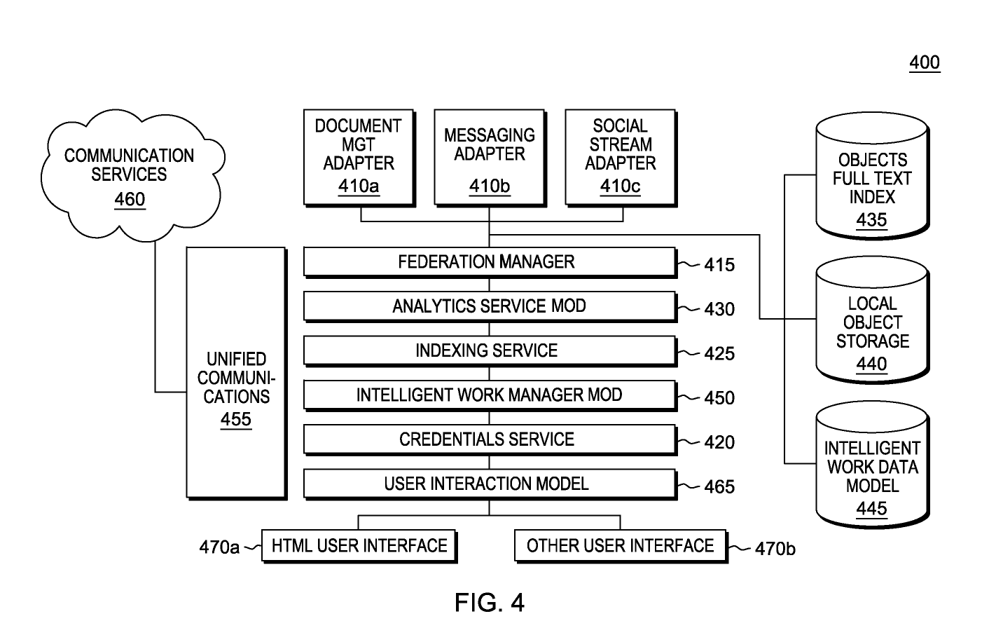

As shown in FIG. 4, an embodiment of the present invention is intelligent client 400, which includes: a set of adapters, including document management adapter 410a, messaging adapter 410b, and social stream adapter 410c; federation manager 415; credentials service 420; indexing service 425; analytics service module 430; objects full-text index 435; local object storage 440; intelligent work data model 445; intelligent work manager module 450; unified communications 455; communications services (network) 460; user interaction model 465; and user interfaces 470a and 470b.

The function of adapters 410a, 410b, and 410c is to provide access functions for a specific type of back-end data source, allowing the intelligent client to read/write those data sources in a consistent way. Document management adapter 410a allows interaction with document-oriented repositories. Messaging adapter 410b allows interaction with email systems. Social stream adapter 410c allows interaction with a multiplicity of social computing platforms and/or capabilities such as social networking sites, blogs, and wikis. Alternatively, some embodiments may include other types of adapters, based on the different data sources that users may wish to access.

The function of federation manager 415 is to maintain a list of the concrete adapters that have been configured, and to invoke the various adapters to pull/push data as needed.

Credentials service 420 maintains and provides access to the credentials needed to access different back ends. For example, federation manager 415, before using messaging adapter 410b to connect to a particular email server, will access credential service 420 to obtain the needed access credentials, tokens, passwords, and so forth needed to connect to that server.

Indexing service 425 has two functions: (i) it maintains full-text index 435 on all objects accessed by the client; and (ii) it performs searches against that index.

Analytics service module 430 maintains additional statistics and classifications on data objects above and beyond the full-text index. Examples of these statistics include: (i) word frequencies; (ii) phrase frequencies; (iii) link counts; (iv) reference counts; (v) natural language processing information; (vi) object categories; and (vii) object priorities. As used herein, “link count” indicates the number of links or other references to an item from external sources, and “reference count” indicates the number of links or other references within an item to external sources. A high link count means a document or other work item is referred to by many others and so may be valuable; a high reference count means a document includes many references, which means it may be valuable in another way.

In the context of intelligent client 400, “link counts” are counts of links to the referenced document or other work item that occur within a user's personal corpus of data; for example, for a given blog post, that post may be linked to by four other blogs to which the user subscribes, so the link count would be four. Many other blogs beyond those the user subscribes to may link to that post, so from the standpoint of the overall enterprise, the link count may be much higher. However, the personalized link count has value because the links from sources to which a user subscribes are likely to have inherently higher value to that user, and therefore so too a link count metric based on those sources. “Reference counts” include the number of contained links wherever they are, both inside and outside of a user's personal corpus.

In the context of intelligent client 400, “natural language processing information” indicates the semantic relationships of the terms contained in a document. For example, say a document contains a phrase representing a particular brand and model name of mobile phone. The overall intelligent client system has access to a variety of information taxonomies, and it uses these taxonomies to determine that this phrase refers to a kind of mobile phone. If a user then searches for “mobile phone”, this document would be included in the search results even if it does not contain the words “mobile” and “phone”.

Intelligent client 400 also maintains object priorities. These include information about direct kinds of priorities such as due dates. Priorities are also assigned by a user to the tasks, projects, and other work domains defined in the model of work (see below), so that a high-priority document or other item of work is one that has been automatically mapped to a high-priority project. When viewing attributes for documents/items of work or lists of documents/items of work, users have access to different kinds of social metrics, such as link count, reference count, number of likes, number of replies, number of shares, and so on, which they can then use in assessing the priority of a work item at a more granular level.

Intelligent client 400 maintains private local object storage 440 for certain classes of objects, such as retrieved email messages. However, many objects of interest to the user are never brought into this store and remain in their remote location; these are identified and accessed by links or pathnames (via, for example, communications services 460).

Intelligent work manager module 450 works to organize objects according to intelligent work data model (work model) 445 of intelligent client 400 by, for example, classifying newly received objects according to an appropriate realm or realms, and generating alerts or actions that aid users in achieving their work goals.

Intelligent client 400 uses unified communications 455 to integrate communications services such as various presence, chat, online meeting, and internet-protocol-based voice and video services. This integration is both at the user-interface level, in that users can initiate communications with others based on names that are displayed in various places across intelligent client user interface 470a and/or 470b, and also at the data level, in that chat transcripts, meeting logs, and other artifacts created by communications can be indexed and incorporated into the overall data space of intelligent client 400.

User interaction model 465 serves to logically organize all state and functionality needed for user interfaces 470a and 470b (see below) to interact with the system according to the business rules of the system. The user interaction model exposes many service application programming interfaces (APIs), which serve as the contact between the different back-end components of intelligent client 400 and user interfaces 470a and 470b. In other words, user interfaces 470a and 470b never interact directly with any intelligent client component other than user interaction model 465.

User interfaces 470a and 470b supply all the rendering and interface logic needed for users of intelligent client 400 to access its features. The main interface supported by the intelligent client is user interface 470a, which is implemented using the HyperText Markup Language (HTML) standard. However, other user interfaces based on other technologies could be created, and here intelligent client 400 also includes user interface 470b based on a platform-independent programming framework.

Intelligent client 400 is deployed as a software program fully resident on a computing device, such as a laptop or tablet; the full stack shown in FIG. 4, which includes 410a, 410b, 410c, 415, 420, 425, 430, 450, 465, and 470a and 470b, therefore resides on the intelligent client device. The only connections made by the system are those opened by adapters 410a, 410b, and 410c to their corresponding back-end systems via communications services 460.

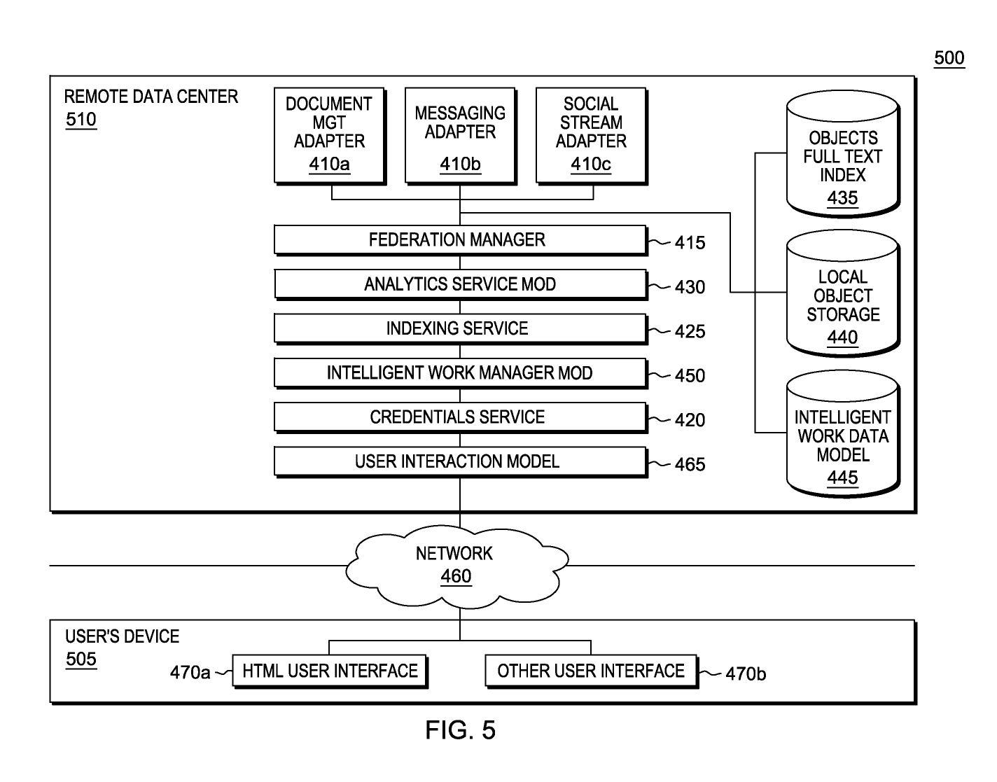

An alternative deployment model is shown in FIG. 5. Here, intelligent client 500 is deployed as an online service as part of a cloud application, with functionality split between user's device 505 and remote data center 510. In this model only user interfaces 470a and 470b are resident on user's device 505. User interface 470a, for example, displays HTML in a standard browser. All other components of intelligent client 500 operate on computing and storage resources located in remote data center 510. Unified communications 455 (not shown is FIG. 5) is also in the cloud with all the other components, and its functions are accessed via user interface 470a or 470b. Alternatively, it may be on the user's workstation as an installed client, and all the user's call logs, chat logs, and so on may be submitted to the cloud system for processing by the cloud-based intelligent client. User interfaces 470a and 470b communicate with user interaction model 465 via network 460, which represents the public Internet. Alternatively, the network may be a private network.

Those of ordinary skill in the art will recognize that other deployment configurations are possible. Because all the components of the intelligent client communicate with each other via service interfaces, their concrete location could be anywhere. Nevertheless, some configurations will be inherently more efficient than others; for example, if an adapter retrieves content to a local workstation, it could be inefficient to submit that retrieved content to a cloud-based indexing service.

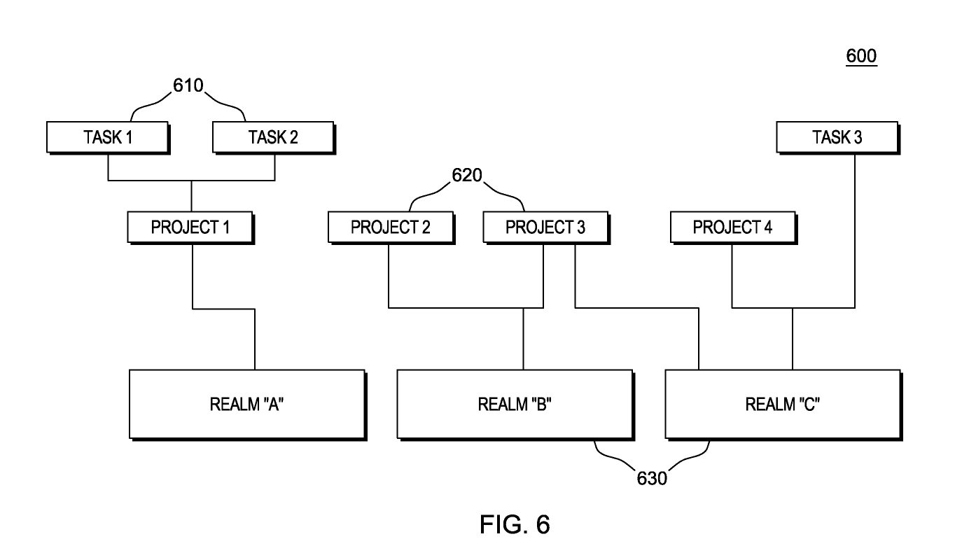

Shown in FIG. 6 is model of work 600, used for intelligent work data model 445 of intelligent client 400 (see FIG. 4). Model of work 600 is a partially ordered relationship of work domains including: realms 630; projects 620; and tasks 610.

Realms 630 are broad areas of work or participation. For example, an engineering manager may use realms like “Product Releases”, “Team”, “Customers”, and “Strategy”. A sales person might use realms like “Deals”, “Training”, “Partnerships”, and “Team”. More generally, realms will correspond to separate, broadly defined responsibilities in a given user's job description. Intelligent client 400 requires that at least one realm be defined in order to provide a consistent experience. Many users may employ no more than a single default realm named “Work”, “Job”, or something similar.

Projects 620 are concrete work deliverables, executed over a span of time, and typically (but not always) worked by teams. Each project is directly linked to one or more realms. Intelligent item categories (discussed further below) link items of work to model of work 600. For example, a document is processed and is found to belong to categories “ABC Bank” and “Security Gateway”. Because there is a mapping from category “ABC Bank” to the project “ABC Bank Upgrade”, the document is linked to that project. Such a linking can happen at any level of model of work 600, including to tasks, to projects, or to realms.

Tasks 610 are finer-grained units of work, such as completion of a document or a specific meeting with a customer. Tasks are usually associated with projects, but in some cases link directly to a realm. The intelligent client user interface allows users to implicitly create a new project, if needed, whenever a task is created.

In the context of intelligent client 400, “mapping” of a data item indicates the connection of that item to one or more items in model of work 600. All data objects initially created by the intelligent client will be created in the context of a selected realm, project or task, and so are implicitly mapped. Subsequent related or child objects—replies to emails or comments to blog posts, for example—will implicitly have the mapping of the parent item.

More broadly, all data objects created or retrieved by intelligent client 400 undergo text indexing and further text analytical processing. This enables automatic categorization and intelligent mapping of each object into categories, which are general types or classes of objects. “Press releases”, “Specifications”, “Problem reports”, and “Status reports” are examples. In the intelligent client, the mapping of actual object properties is devised through a combination of automated suggestions and learning based on user choices. It is via these intelligent associations that the user can see on their dashboard what new items exist for each of their realms, projects, and other domains of work that have been defined.

Categories are analogous to social networking tags, meaning they serve to classify the item. Multiple category assignments can be made for any item. In some embodiments of the present invention, the intelligent client system includes a capability to map documents to categories; for each input document, the system assigns it one or more categories. There are multiple ways this can be done, but the end result of all methods is the same in that documents are assigned to one or more categories. The actual creation of categories, in some embodiments of the present invention, can happen in any of the following ways:

(i) Categories can be taken from unique terms or phrases in documents. For example, say the phrase “Children's Hospital” is identified in a document, and that additionally, the analytics system determines that this phrase is not pervasive across all the user's documents (that is, some but not all documents have this phrase). The system then offers this phrase as a candidate category and the user may confirm “Children's Hospital” as a new category. Alternatively, the system may identify this phrase but the user may not wish to define a new category. Instead, the user chooses to map the phrase to an existing category. For example, the system may identify the name “Arthur Brown” as a unique phrase. Because the user knows that Arthur Brown is a doctor at Children's Hospital, the user chooses to map documents containing this name to the existing category “Children's Hospital” rather than to define a new category. The user can also choose to auto-categorize documents originating from arthur.brown@chhosp.com as being in the “Children's Hospital” category.

(ii) Another way that categories may be devised is by cluster analysis. In cluster analysis, a set of documents is examined to determine what similarity groupings exist in the set; these are subsets of documents that are similar to each other. The clusters are typically represented by the most unique phrase in the subset. For example, if a user searches for the term “virus”, the returned documents may cluster into subsets named “computer virus”, “common cold”, and “viral marketing”. The identification of unique phrases via clustering is another means of auto-assigning categories.

(iii) Inasmuch as the presence of words or phrases may be used to drive assignment of categories, it is not necessary that a single word or phrase drive the category mapping. Categories may be inferred based on a combination of phrases. For example, documents containing both “Widget Co.” and “web portal” may be selected as mapping to category “Widget Co. web portal project”, but the occurrence of one or the other of these phrases alone would not map to that category.

(iv) Yet another way that categories may be devised is by example. With this approach, a user starts with a given document that the user considers an exemplar of one or more categories. The user enumerates the categories, then the system analyzes the exemplar document to see what unique content the document contains that can drive assignments to these categories. Alternately, the system may use a document similarity algorithm such as a vector space model, and use a relevance percentage to drive the categorization (for instance, if a candidate document has greater than or equal to 70% relevance compared to the exemplar, then the candidate document will be assigned to the specified categories).

Some embodiments of the present invention recognize that the hardest part of this process may be initial category creation. A typical user already has many thousands of documents. In the initial indexing, there may be many inferred categories, such as those based on the occurrence of unique terms or phrases. The user conceivably could go through all of these and determine how to map those phrases to concrete categories. These embodiments further recognize that most users may prefer not to categorize their backlog, and instead categorize only new items. In this case, a category defined based on phrases in a newly received document could be used to auto-categorize the backlog. Alternatively or in addition, the user could still do a full-text search on all their data, and they might choose to categorize certain of the documents found.

In some embodiments of the present invention, the mapping of documents to work domains is “loose”. This means that when a document is auto-categorized, and if subsequently linked to a work domain, the user can later override that linkage and move the document to a different work domain. But this does not change the categories of the document. The categories of a document never change, unless the user explicitly adds or removes categories.

In some embodiments of the present invention, the linkage of a document to a work domain is by reference. There can therefore be multiple references for a single document to multiple work domains. Say a user has two work domains, “Projects” and “Innovation”; the user also has category “Children's Hospital”. Because “Children's Hospital” is a project it is mapped to “Projects”, but because the work is also innovative it may also be mapped to “Innovation”. If a user is looking at any dashboard or listing for work domains, documents categorized as “Children's Hospital” will then show up in the display for each of these two work domains.

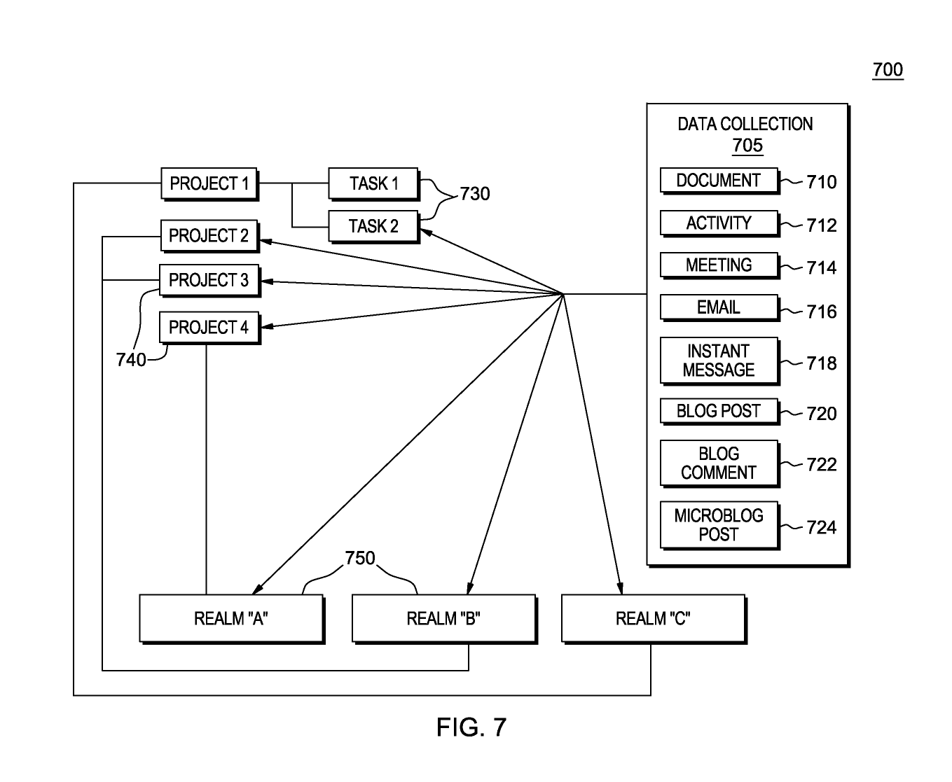

Graphically this process works as shown in FIG. 7, which shows model of work categorization diagram 700 for intelligent work data model 445 of intelligent client 500 (see FIG. 5). Diagram 700 includes: tasks 730; projects 740; and realms 750, which together make up the model of work. Diagram 700 also contains data collection 705, which includes document 710, activity 712, meeting 714, email 716, instant message 718, blog post 720, blog comment 722, and microblog post 724. For each item in data collection 705, intelligent client 500 categorizes it and then assigns it to the appropriate task(s), project(s), and/or realm(s) based on the mapping(s) of the category or categories to which the items of data collection 705 are assigned. For example, analytics are run on blog post 720, and based on the results blog post 720 is assigned to a category designated “Problem reports for System Y” (not shown). “Problem reports for System Y” has been mapped to Task 2, so blog post 720 becomes associated with Task 2, Project 1, and Realm C based on the model of work.

The intelligent mapping capability of clients 400 and 500 refer not just to the automatic categorization of data items and the connection of categories to items in the model of work, but to the learning capability of the intelligent client. For example, a new item is indexed and the category “Technical” is inferred. Based on the user's category mappings this item is assigned to the realm “Projects”. However, when the user reads the document they determine this particular item more properly should be included in the “Customers” realm (perhaps because it concerns a customer problem). When the user drags the item from the initial realm to the correct realm, the client “remembers” this action and in the future will assign similar documents to the “Customers” realm. Optionally, the client may prompt the user with a list of unique phrases from the item so that the user may select which phrase(s) best typify the assignment to “Customers”.

In some embodiments of the present invention, when a user begins work for the day and activates an intelligent client application, the application begins to retrieve data from the different data sources that have been configured. The intelligent client does this in an asynchronous fashion, so the user may work on other activities in the client while the retrieval is underway. When retrieval is complete, the user can consult the intelligent client dashboard. The dashboard shows how many new items have appeared for each of the user's realms. Other information on the dashboard includes aging of items by realm, allowing the user to see at a glance which realm has the oldest items needing attention.

Some embodiments of the present invention use intelligent categorization to enhance search functionality. For example, suppose an analyst wishes to do a quick assessment on a company someone recently mentioned. He believes he has come across the name before but is not sure where. He initiates a search on the name from the intelligent client. When the search completes, he sees a list of “hits” ordered by relevance to the name, the total number of hits, and a specialized “results pivot” user interface control showing categories and realms. On the results pivot, the analyst sees a list of all categories represented in the results. In a single action, he can either remove an entire category's worth of results from the returned set, or restrict the set to show only those results from a single selected category. For instance, the target company name may show up in categories like “Press Releases”, “Competitors” or “News”. Depending on his original motivation for the search, he may wish to focus on hits from a single one of these categories. Alternatively or in addition, the results pivot may show the types of items, such as email, document, or blog, that are included in the list of hits. If he recalls that the info he wants to find was a blog entry, he can quickly eliminate the other two types of hits.

Some embodiments of the present invention present a standardized interface for composing messages for multiple services and service types. For example, suppose a manager needs to create a communication for her team. To start, she selects the “My Team” realm. This displays the different feeds that are linked to this realm, such as “Manager News”, “Hiring”, and “Team Communications”. The manager selects this last feed and further selects the “New Post” command. This activates an editing experience similar to that for any document or email, including rich text options, tables, indents, bullets, and the like. The manager composes the needed communication and when complete clicks “Post” or “Send” or some similar command. In this case the result is a new post on the manager's team blog.

To continue this example, the manager next consults her “Customers” realm. Here she sees a to-do for an on-site demo with a particular customer. Quickly consulting the documents she has linked to this customer (see the above example on search), she determines the best dates for the demo. She selects the entry for the customer and clicks “Reply”. This invokes the identical editing user interface that was employed for the team communication; the only difference is that the name and address of the customer contact is shown. The manager composes her note. As it is completed, she decides that other people should be informed of her proposal, so she selects a community that has been created for sales/support engagement with this customer as an additional “addressee”. Finally, two actions occur when she clicks the send command: (i) a standard Simple Mail Transfer Protocol (SMTP) email is sent to the customer; and (ii) a post containing the body of the message is made in the selected community's forum.

Some embodiments of the present invention allow a user to work with projects and tasks. For instance, a financial services manager is reviewing some goals he would like to address in the coming month. The goals range from updating his team on a soon-to-be-announced reorganization, meeting with institutional investor customers for quarterly updates, and collaborating with product managers to devise sales-plays for new financial products.

From his personal dashboard, the manager selects the realm “Team” and from there creates the task “All-hands for Reorg”. Because he is not certain of the specific date for the meeting, he selects an entire week that is three weeks away as the time for task completion. There is a “type” option he can select for the task. The manager chooses the type “Meeting”. An optional list of items to be created for the task is included here as part of the task information. The manager chooses “presentation” and “blog”, because he intends to both present information in the projected meeting as well as create a blog entry about the reorganization. He then saves the task.

Next the manager goes to the “Customers” realm. This time he selects an existing project, “Institutional Updates”. In the summary for this project he can see links to lists of items, such as documents and meetings, that are associated with the project. The manager selects a task that corresponds to the last update he provided these customers and elects to “clone” it, meaning that the previous task is used as a template for a new task.

Finally, the manager goes to the “Development” realm and there creates a new project, entitled “Sales Plays 2013”. Part of the optional information for the project is a list of people who participate in the project, selected by the manager from his list of contacts. (Note that absent other information to the contrary, the intelligent client will subsequently link received items authored by those users, such as emails, documents, and so on, to this project.) To get the project started the manager creates an “Entry” (activity). The manager composes the text for the entry and saves it. All the selected project participants will then be invited to the newly created activity.

Day by day as the manager works with the intelligent client, the personal dashboard will show status on these projects and tasks, for example indicating when milestones are due and when new items linked to the projects and/or tasks have been received.

Some embodiments of the present invention provide unified communications and collaboration (UCC) integration such as that illustrated in the following example. A product manager is working on defining a new offer that is a combination of products and standardized services. She has defined a project for this work in the intelligent client. Going to the project homepage, she sees one of the project contacts is online and decides to ask a question via chat. The product manager and her project contact conclude the chat, at which point the transcript of the chat is saved and tagged such that it is linked to the original project. The same will happen with phone calls, audio/video calls or online meetings initiated from the context of a project: the log and transcript or recording (if available) of the communication will be saved such that it is linked to the project. In the case of communication initiated outside the context of a project, for example by just selecting a contact from a contact list, the intelligent client will prompt the user on how to classify the just-completed communication once it has concluded. An option to “Remember this decision” is provided, which signals to the client how such communications should be tagged in the future.

Some embodiments of the present invention may include one, or more, of the following features, characteristics and/or advantages: (i) federate data from different sources; (ii) include analytics and/or intelligence; (iii) organize data around a goal-oriented “model of work”; (iv) apply to both inbound and outbound data for a particular user; (v) include intelligence for automatic organization of work items driven by analytics; (vi) assign an item to a given category based on the identity of the item' s author; (vii) federate data items into a single stream or into categories; (viii) have analytics to automate item classification; (ix) possess a model-of-work; (x) use analytics of free-form data; (xi) possess searching capabilities; (xii) facilitate goal/task management; (xiii) perform “knowledge work” in the sense of business user requirements; (xiv) perform intelligent posting, where the proper channel is chosen for a user based on context; (xv) use intelligent categorization or classification; and/or (xvi) provide a “model of work” which organizes user information.

Some embodiments of the present invention use analytics to determine the task-affinities of different objects, most of which the user has never before accessed. For example, if a user is granted access to a social community group, these embodiments will automatically analyze all the content in that community (files, blogs, wikis, and so on) and whether or not the user had ever visited that community, will link items to the user's model-of-work.

Some embodiments of the present invention are based on text analytics, together with user guidance and machine learning, to automatically and intelligently map objects to a user's tasks and projects.

Some embodiments of the present invention may include one, or more, of the following features, characteristics and/or advantages: (i) use analytics as a process which automatically and without human engagement performs the work of indexing and sorting; (ii) are fundamentally more efficient and more correct because no human presence or action is required; (iii) use analytics to process large numbers of items in a mathematically consistent way; (iv) process items a user would never be able to touch, or even know he needed to touch; and/or (v) learn user choices and use them to classify future items the user never touches.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Work domain: a scope of work; “realms” which are separate, broadly defined responsibilities in a given user's job description, “projects” which are concrete work deliverables executed over a span of time and typically worked by teams, and “tasks”, which are units of work for finely grained than realms or projects, are examples of work domains; work domains may be related to each other in any number of ways, such as via (exclusive) nesting, partial ordering in a hierarchy, or less constrained associations such as a graph or other network structure.

Model of work: a partially ordered set of work domains, with domains of more limited scope defined as subsets of a domain(s) of broader scope only if their scopes at least partially overlap.

Item of work: includes, but is not necessarily limited to, documents, email messages, instant messages, social updates, blog posts, calendar events, video clips, etc.

Analytics: the discovery of meaningful patterns in data, such as via comparison of one or more statistics or characteristics of a set of data against some reference; includes drawing conclusions about relationships from a combination of statistics and/or characteristics.

Advanced analytics: the use of relatively sophisticated analytics techniques to draw out from a set of data information, including conclusions about relationships, that is not readily digestible by a computer, does not use a simple algorithm, and/or is not intuitive to seek; examples are text natural language processing, video object detection algorithms, and steganographic noise floor consistency analyses.

Adaptive analytics: analytics that use machine learning in an attempt to improve the quality of their analyses with respect to future data.

1-7. (canceled)

8. A computer program for classifying items of work, the computer program product comprising software stored on a software storage device, the software comprising:
first program instructions programmed to receive a first item of work;
second program instructions programmed to apply a first set of analytics to data pertaining to the first item of work to obtain metadata about the first item of work;
third program instructions programmed to apply a second set of analytics to the data and/or metadata to classify the first item of work as belonging to a first work domain in a model of work;
fourth program instructions programmed to receive user feedback regarding the accuracy of the classification of the first item of work; and
fifth program instructions programmed to, update the second set of analytics in response to the user feedback such that a second item of work, when received, is classified differently than it would have been had the feedback not been received;
wherein:
the software is stored on a software storage device in a manner less transitory than a signal in transit.

9. The product of claim 8 wherein the data analyzed includes social data.

10. The product of claim 8 wherein the first set of analytics includes advanced analytics.

11. The product of claim 8 wherein the second set of analytics includes advanced analytics.

12. The product of claim 8 wherein the first and/or second sets of analytics includes natural language processing.

13. The product of claim 8 further comprising:
a first subset of the third program instructions, programmed to create a first category;
a second subset of the third program instructions, programmed to classify the item of work into the first category; and
a third subset of the third program instructions, programmed to link the first category to the first work domain.

14. The product of claim 8 further comprising:
sixth program instructions programmed to suggest a first recipient of a third item of work that belongs to the same work domain as the first item of work, based at least in part on the data and/or metadata pertaining to the first item of work and the classification of the first item of work.

15. A computer system for classifying items of work, the computer system comprising:
a processor(s) set; and
a software storage device;
wherein:
the processor set is structured, located, connected and/or programmed to run software stored on the software storage device; and
the software comprises:
first program instructions programmed to receive a first item of work;
second program instructions programmed to apply a first set of analytics to data pertaining to the first item of work to obtain metadata about the first item of work;
third program instructions programmed to apply a second set of analytics to the data and/or metadata to classify the first item of work as belonging to a first work domain in a model of work;
fourth program instructions programmed to receive user feedback regarding the accuracy of the classification of the first item of work; and
fifth program instructions programmed to, update the second set of analytics in response to the user feedback such that a second item of work, when received, is classified differently than it would have been had the feedback not been received.

16. The system of claim 15 wherein the data analyzed includes social data.

17. The system of claim 15 wherein the first and/or second sets of analytics includes advanced analytics.

18. The system of claim 15 wherein the first and/or second sets of analytics includes natural language processing.

19. The system of claim 15 further comprising:
a first subset of the third program instructions, programmed to create a first category;
a second subset of the third program instructions, programmed to classify the item of work into the first category; and
a third subset of the third program instructions, programmed to link the first category to the first work domain.

20. The system of claim 15 further comprising:
sixth program instructions programmed to suggest a first recipient of a third item of work that belongs to the same work domain as the first item of work, based at least in part on the data and/or metadata pertaining to the first item of work and the classification of the first item of work.
